(19) United States
(12) Patent Application Publication
(10) Pub. No.: US 2015/0226279 A1
(43) Pub. Date: Aug. 13, 2015

(54) SPRING HAVING A CORE STRUCTURE

(71) Applicant: Peter Robert Scholar, Grand Blanc, MI (US)

(72) Inventor: Peter Robert Scholar, Grand Blanc, MI (US)

(21) Appl. No.: 14/619,518

(22) Filed: Feb. 11, 2015

Related U.S. Application Data
(60) Provisional application No. 61/939,013, filed on Feb. 12, 2014.

(51) Int. Cl. F16F 1/36; F16F 1/06; F16F 1/368; F16F 1/10; F16F 1/02; F16F 1/366; F16F 1/18; F16F 1/08

(52) U.S. Cl. CPC F16F 1/3605; F16F 1/18; F16F 1/06; F16F 1/08; F16F 1/10; F16F 1/021; F16F 1/366; F16F 1/3665; F16F 1/368

(57) ABSTRACT

A spring having a sandwich-structured composite including a core structure, a top skin, and a bottom skin. The core structure comprises a framework, or array of geometric shapes designed to absorb and distribute the forces applied to the spring. Preferably the framework comprises an array of hexagonal columns that extend between the top and bottom skins. The top and bottom skins are laminated to a respective top and bottom surface on the core structure. The spring can comprise any suitable type of spring that is well-known in the art, including a leaf spring, a coil spring (or helical spring), a torsion spring (or clock spring), a conical spring, and so forth.

### CROSS REFERENCE TO RELATED APPLICATION

This application claims the benefit of U.S. Provisional Application 61/939,013, which was filed on Feb. 12, 2014, the disclosure of which is hereby incorporated by reference.

### BACKGROUND OF THE INVENTION

1. Field of the Invention

The present invention pertains to a spring having a hollow core structure. More particularly, the present invention pertains to a spring having a hollow core structure that includes an array of hexagonal columns.

2. Description of the Prior Art

Conventional solid springs have been well-known in the art for hundreds of years. There are numerous types of springs that are commonly used. For instance, leaf springs, which have a generally rectangular cross-section, are commonly used in automobiles and other vehicles. Leaf springs have been commonly used on horse-drawn carriages and wagons for hundreds of years before they were even used on automobiles.

In addition, there are coil (or helical) springs, torsion (or clock) springs, and conical springs, among others, which have been in common use for many years.

The physical geometry of springs is believed to have seen very little innovation in many years. Thus, it is believed that any current technology in the field of springs likely pertains to the materials used. Accordingly, the weight of springs has not been reduced other than by making the springs from a lighter material like aluminum or titanium, which is inevitably more expensive.

As energy costs continue to increase, there is a growing demand for an increase in vehicular fuel efficiency. This trend may be most pronounced in the automotive field. One way that fuel savings are accomplished is by reducing vehicle weight while maintaining structural strength and safety standards. In some cases, steel has been replaced by aluminum, or even titanium. Although significant advances have been made in reducing the weight of engine blocks, vehicle frames, and body panels, there has been no known advances in the way of reducing the weight of springs other than changing the material type. Steel automotive springs can weigh about 15 pounds per spring, totaling 60 pounds per vehicle.

Titanium springs are available and can weigh 60%-70% lighter than those made from steel. However, titanium springs can still weigh 18 to 24 pounds (depending upon the vehicle size), and the additional expense to upgrade to titanium can be significant. It is believed that titanium springs can never be a mainstream replacement for steel springs because they are cost prohibitive.

Thus, there remains a need for a spring that is lighter yet matches the performance and reliability of currently-available springs, but which does not have its cost tied into a commodity like titanium.

The present invention, as is detailed hereinbelow, seek to improve upon the existing springs by providing a spring having a hollow core structure which provides a construction that is lighter than traditional springs, yet remains structurally sound and reliable.

### SUMMARY OF THE INVENTION

The present invention provides a spring comprising a sandwich-structured composite having a core structure, a top skin, and a bottom skin, the top and bottom skins being laminated to a respective top and bottom surface on the core structure.

The spring can comprise any suitable type of spring that is well-known in the art, including a leaf spring, a coil spring (or helical spring), a torsion spring (or clock spring), a conical spring, and so forth.

The core structure comprises a framework, or array of geometric shapes designed to absorb and distribute the forces applied to the spring. Preferably the framework comprises an array of hexagonal columns that extend between the top and bottom skins.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a first embodiment of the present invention hereof;

FIG. 2 is a front perspective view of a second embodiment of the present invention hereof;

FIG. 3 is a top perspective view of the second embodiment of the present invention hereof;

FIG. 4 is an enlarged front view showing the sandwich-structured composite hereof;

FIG. 5 is an example of the core structure in the form of an array of hexagonal columns;

FIG. 6 is another embodiment of the invention hereof showing a leaf spring;

FIG. 7 is another embodiment of the invention hereof showing a torsion spring;

FIG. 8 is another embodiment of the invention hereof showing a conical spring;

FIG. 9 is a helical spring embodying the present invention showing the various spring specifications;

FIG. 10 is an example of the core structure showing the various core specifications; and

FIG. 11 is a top view of an example of the present invention having a square-shaped cross-section when viewed from atop.

### DETAILED DESCRIPTION OF THE PREFERRED EMBODIMENT

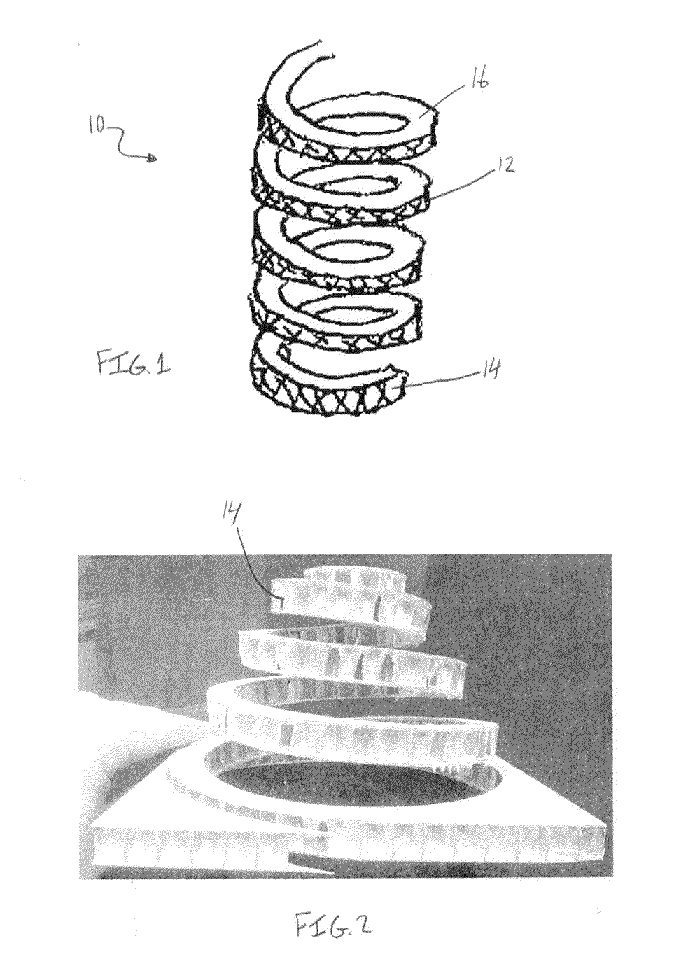

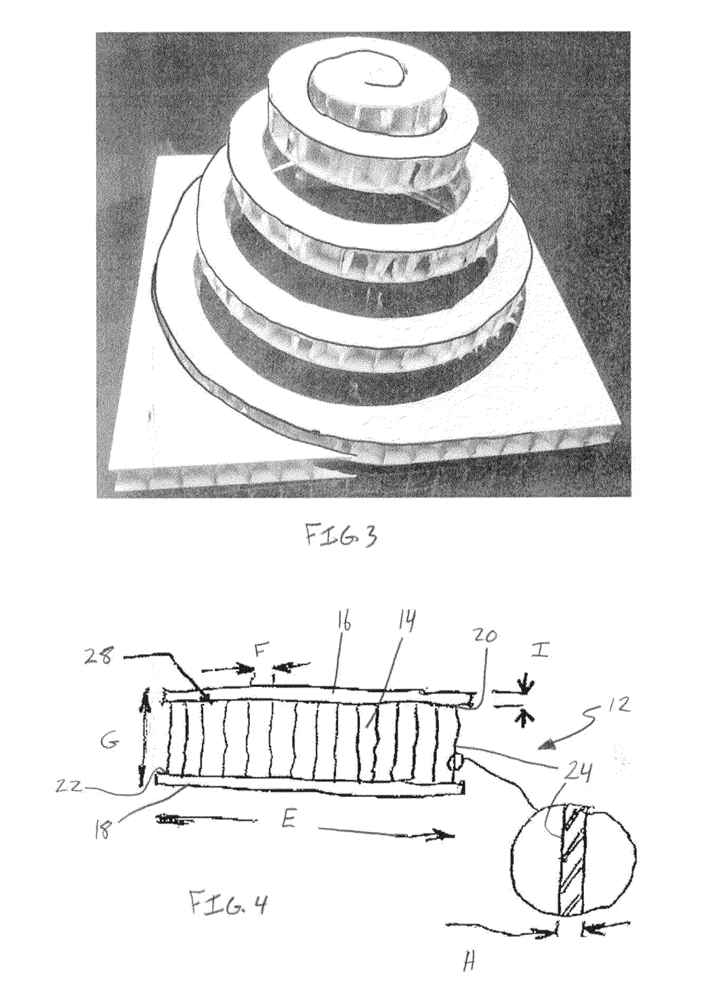

In accordance with the present invention, and as shown generally in FIGS. 1-3, there is provided a spring 10 comprising a sandwich-structured composite 12 having a core structure 14, a top skin 16, and a bottom skin 18, the top and bottom skins 16,18 being laminated to a respective top and bottom surface 20,22 of the core structure 14.

The spring 10 is an elastic object used to store mechanical energy. The spring is elastically flexible and has at least two connection points which can be secured to external structures to transmit (or absorb) a force between the two structures.

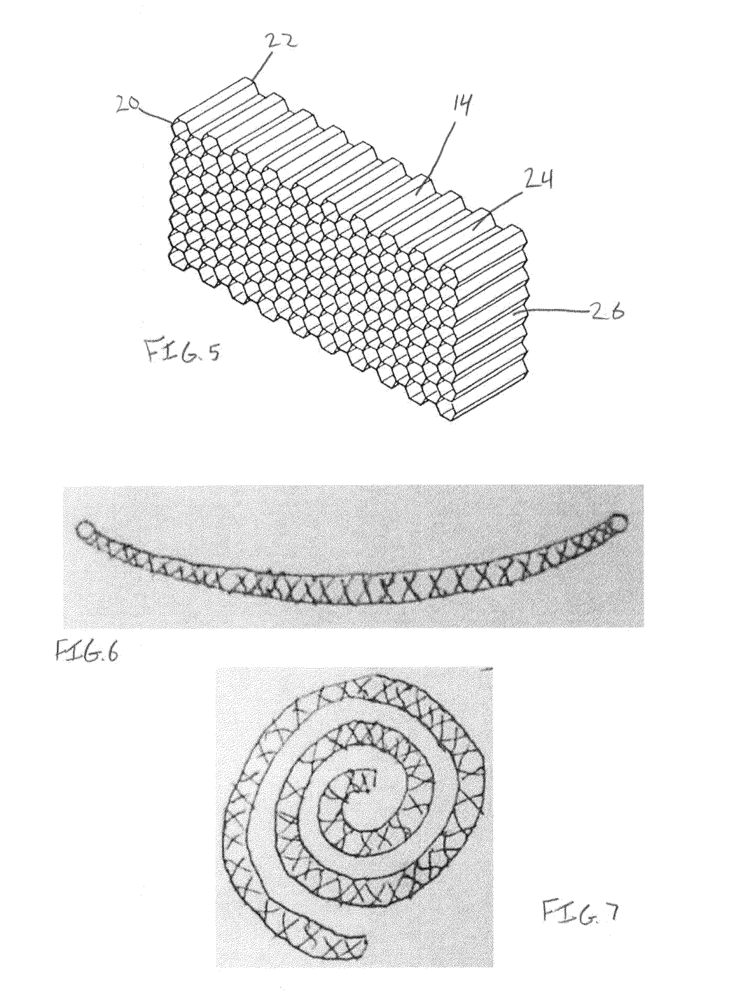

As shown in FIG. 4, the sandwich-structured composite 12 comprises the medially-located core structure 14. The core structure 14 is a hollow framework that absorbs and distributes forces applied to the spring 10. The core structure 14 can be formed by an array of any suitable type of geometric shapes or configurations which extend between the top and bottom skins 16,18. Preferably the core structure 14 comprises a plurality of interconnected walls 24 that extend between the top and bottom skins 16,18. The interconnected walls 24 define an array of hexagonal columns 26, such as shown in FIG. 5. However, any other suitable type of geometric configuration can be used. For example, the core structure 14 preferably comprises a regular tessellation, which is a pattern made using a regular polygon, such as a hexagonal or triangular tessellation. Semi-regular tessellations may optionally be used as well. There are eight semi-regular tessellations that exist, and each can optionally be used. Tessellations are preferable because their reoccurring geometry lends to an even distribution of force across the length of the spring 10. But as mentioned above, a hexagonal tessellation is most preferred.

As preferably shown in the drawings, only a single-level composite 12 is shown having one top skin 16, one bottom skin 18, and one continuous core structure 14. However, multi-level skin and core structures (not shown) can optionally be stacked to provide multiple layers depending upon the various performance characteristics that are desired.

The skins 16,18 and core structure 14 can be formed from any suitable type of material, which will vary significantly depending upon the size and stiffness of the spring 10. In more demanding performance areas, such as for automotive use, metal and/or composite materials are preferable. Examples of suitable materials include, but are not limited to, metals (e.g., aluminum, titanium, steel, etc.), paper or cellulosic-based materials, modified cardboard, engineered plastics or composite materials including fiber-reinforced polymers like fiberglass, carbon fiber, aramid-reinforced polymers, Nomex®-reinforced polymers, Kevlar®-reinforced polymers, and non-aramid plastics. Furthermore, the skins 16,18 and the core structure 14 can be formed from the same material or from different materials.

Preferably the skins 16,18 comprise a rigid material. The core structure 14 can comprise either a rigid material or a material that can flex at the points where the walls 24 interconnect. Preferably the core structure 14 is of the type which can flex.

The skins 16,18 and the core structure 14 can be adhered together using any suitable method depending upon the particular type of material. For example, welding, rivets, or the like can be used if the skins 16,18 and core structure 14 are metal. Adhesives 28 can be used if the materials are paper-based or polymeric-based. The skins 16,18 and core structure 14 can potentially be integrally formed together when possible, such as by being injection molded as a single piece.

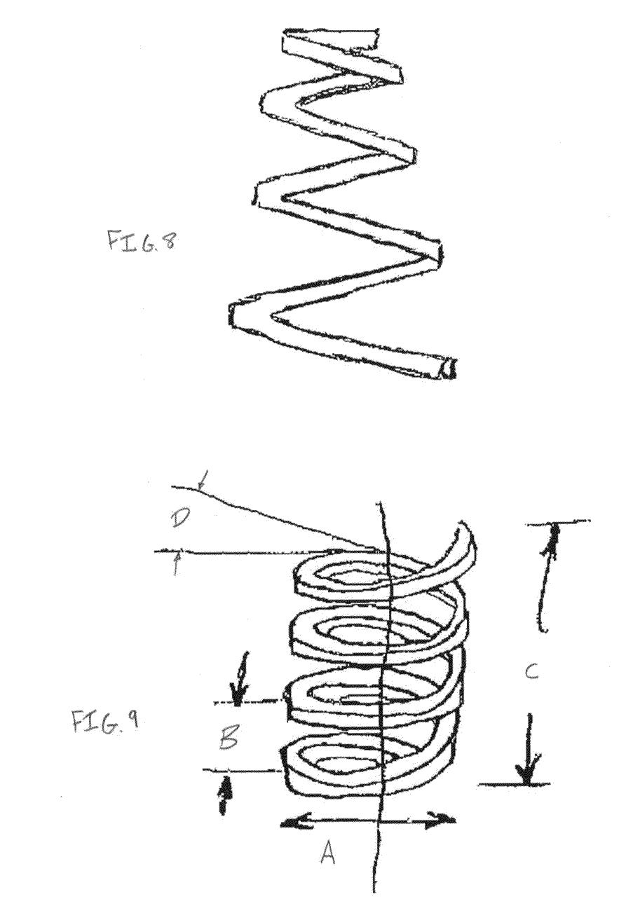

The spring 10 can comprise any suitable type of spring that is well-known in the art, including a leaf spring (see FIG. 6), a coil spring (or helical spring) (which can be either a compression spring or a tension spring), a torsion spring (or clock spring) (see FIG. 7), a conical spring (see FIG. 8), or the like. Just as with a spring in the prior art, the size, number of coils, thickness of the coils, and distance between the coils are all variables that can be specified depending upon the performance demands required of that particular spring.

As shown in FIG. 11, when the spring 10 has a wrapped, or repetitive geometry, such as a coil spring, a conical spring, or a torsion spring, the coils in the spring 10 can form any suitable type of geometric shape, such as circular, oval, squared, rectangular, and so forth.

The hollow-core structure 14 in the spring 10 preferably is hollow and void of any material. Alternatively, the voids between the walls 24 can be filled with a volume of a fluid 30 to provide damping characteristics to the spring 10. The fluid 30 can comprise any suitable type of fluid, such as an oil or the like. In one particular embodiment, the fluid 30 can comprise a magnetorheolocial fluid in which the viscosity varies in the presence of an electromagnetic field, such that the damping rate of the spring 10 varies depending upon the viscosity of the fluid 30.

Another alternative for varying the spring rate in the spring 10 could be to provide a core structure 14 that has varying dimensions and/or geometry along the length of the spring 10 such that the spring rate at one specific portion (e.g., the middle of the spring 10) has one spring rate, and the ends (or top and bottom) of the spring 10 have a different spring rate. Thus, it may be possible to provide a self-damping spring 10 which could further reduce vehicle weight if shock absorbers are no longer needed.

The spring 10 can be manufactured using any suitable method or technique. For example, when the core structure 14 comprises a material that can flex where the walls 24 interconnect, then the core structure 14 can be positioned as desired, such as by being flexed upward and downward, or side-to-side. The skins 16,18 are then placed on the top and bottom of the core structure 14, and the skins 16,18 are adhered to the core structure 14, thereby locking the core structure 14 into position. The spring 10, as a whole, will have the desired tensile and compression characteristics that are desired resulting from the flex that occurs in the core structure 14 and the adhesion with the skins 16,18. This could be a suitable method of manufacture for a leaf spring, a tension spring, or a conical spring.

Another method of manufacture, which could be suitable for a helical spring 10, a conical spring, or a tension spring, could involve winding up a length of the flexible core structure 14 and adhering the top and bottom skins 16,18 thereto.

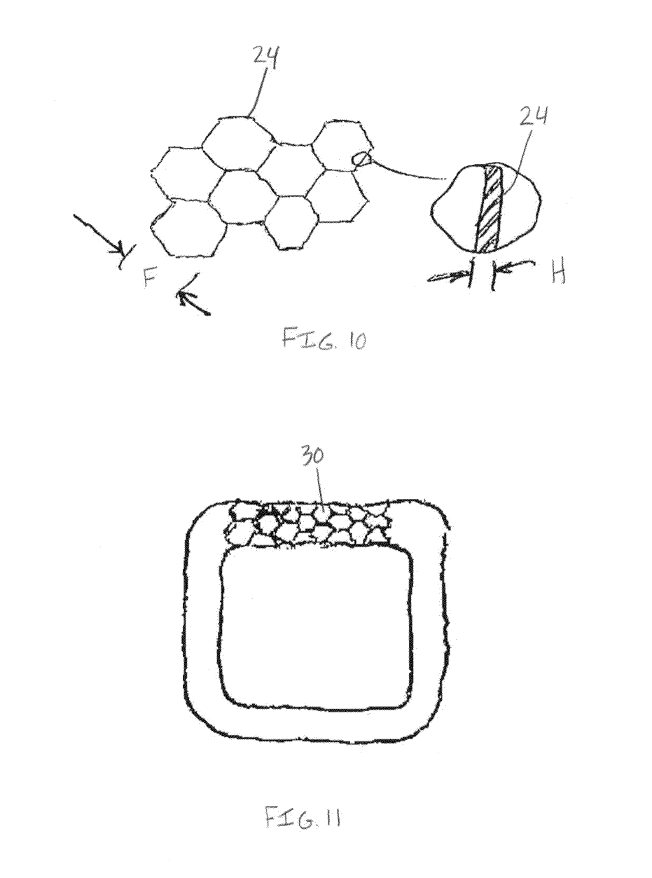

As shown in FIGS. 4, 9, and 10, there are a number of variables and engineering specifications that the spring 10 presents for varying the spring rate and damping rate. As one would find with a spring 10 in the prior art, the helix diameter A, spacing B, height C, and angle D are variable factors. In addition, within the core structure 14 there are also a large number of variables, including but not limited to, the geometry of the walls 24 and columns, the width E, core spacing (or size) F, the core height G, the core material, the wall thickness H, the skin thickness I, the wall material, and the adhesive 28 (or other means for adhering the skins 16,18 to the core structure 14).

According to the invention described above, a spring is provided which has a construction that is lighter than traditional springs, yet remains structurally sound and reliable.

What is claimed is:

1. A spring comprising a sandwich-structured composite having a hollow core structure, a top skin, and a bottom skin, the hollow core structure having a top surface and a bottom surface, and the top and bottom skins are laminated to the respective top and bottom surfaces on the hollow core structure.

2. The spring of claim 1 wherein the hollow core structure comprises a plurality of interconnected walls.

3. The spring of claim 2 wherein the interconnected walls define an array of hexagonal columns.

4. The spring of claim 3 wherein the sandwich-structured composite is formed from a material from a group consisting of: a metal, a paper-based material, an engineered plastic, a fiber-reinforced polymer, carbon fiber, an aramid-reinforced polymer, and a non-aramid plastic.

5. The spring of claim 4 in which the spring is of the type selected from a group consisting of: a leaf spring, a coil spring, a torsion spring, and a conical spring.

6. The spring of claim 2 in which the spring is of the type selected from a group consisting of: a leaf spring, a coil spring, a torsion spring, and a conical spring.

7. The spring of claim 3 in which the spring is of the type selected from a group consisting of: a leaf spring, a coil spring, a torsion spring, and a conical spring.

8. The spring of claim 2 wherein the sandwich-structured composite is formed from a material from a group consisting of: a metal, a paper-based material, an engineered plastic, a fiber-reinforced polymer, carbon fiber, an aramid-reinforced polymer, and a non-aramid plastic.

9. The spring of claim 8 in which the spring is of the type selected from a group consisting of: a leaf spring, a coil spring, a torsion spring, and a conical spring.

10. The spring of claim 1 wherein the sandwich-structured composite is formed from a material from a group consisting of: a metal, a paper-based material, an engineered plastic, a fiber-reinforced polymer, carbon fiber, an aramid-reinforced polymer, and a non-aramid plastic.

11. The spring of claim 10 in which the spring is of the type selected from a group consisting of: a leaf spring, a coil spring, a torsion spring, and a conical spring.

12. The spring of claim 1 in which the spring is of the type selected from a group consisting of: a leaf spring, a coil spring, a torsion spring, and a conical spring.
